(19) United States
(12) Patent Application Publication
(10) Pub. No.: US 2002/0144378 A1
(43) Pub. Date: Oct. 10, 2002

(54) Free-positioning hinge

(76) Inventor: Chia Yu Liao, Taipei (TW)

Correspondence Address: Chia Yu Liao, 235 Chung - Ho, Box 8-24, Taipei, TW

(21) Appl. No.: 10/042,458

(22) Filed: Jan. 10, 2002

(30) Foreign Application Priority Data
Apr. 10, 2001 (TW) 090205536

(51) Int. Cl. E05D 11/08

(52) U.S. Cl. 16/342

(57) ABSTRACT

A free-positioning hinge includes a rotary shaft and a sleeve. The free-positioning hinge is suitable to be used in an open-able device. The sleeve is formed by a plurality of equilateral triangular sheets which are stacked one by one. The center portion of each side of each triangular sheet is extended with a tongue. The center of the triangular sheets is formed as a round main axial hole having a diameter approximately equal to that of the rotary shaft. Furthermore, at each apex of each triangular sheet aside the main axial hole is disposed with a semi-circular sub-hole so as to increase the flexibility of the equilateral triangular sheets. Therefore, oil stored in the sub-holes can be supplemented to the friction surface between the sleeve and the rotary shaft so as to retain in a lubricating condition.

### FIELD OF THE INVENTION

The present invention relates to a hinge, and particularly to a free-positioning hinge formed by a rotary shaft and a sleeve.

### BACKGROUND OF THE INVENTION

The free-positioning hinge is widely used in assembling the machine body of electronic devices, for example, notebook computers, personal digital assistants, etc., having two portions which are pivotally connected through the hinge. In these devices, as the display is opened to a position, it can be positioned in that position so not to fall down due to the gravitational force. In this hinge, the friction force between a rotary unit and a stator unit is utilized to cancel the twisting force of the gravitational force. Therefore, the size of the frictional force is a key point in designing the hinge. If the friction force is too large, not only a large force is necessary to open the device, but also the wearing between two portions of the device is also large. If the friction force is too smaller, then it is very possible that one portion slides with respect to the other portion. Other than the precision, the construction is also an important consideration in designing the hinge.

In the prior art, a hinge is mainly formed by pivotally connecting a sleeve with a rotary shaft. However, these devices are lack of a means for resisting the twisting force induced from the two components. Once the volume of the machine body or the weight of the device to be installed with the hinge is changed, the hinge must be further designed. Therefore, new molds are required. However, currently, the machine bodies of electronic devices are changed frequently. Thus, the prior design is not economical. Next, the prior designs have no space for receiving lubricating oil. Therefore, the lubricating oil can not be contained in the friction surface for a long time period and thus the effect of lubrication is reduced day by day so as to increase the wearing between two connecting components. After being used for a longer time, the friction force is not sufficient to support the twisting force.

### SUMMARY OF THE INVENTION

Accordingly, the primary object of the present invention is to provide a free-positioning hinge, wherein a sleeve is designed by stacking a plurality of thin sheets and the length thereof is determined by the number of the equilateral triangular sheets. If a larger friction force is required, the number of the sheets can be increased. On the contrary, if a small friction force is required, the number of the sheets can be reduced. Therefore, it is unnecessary to make several molds for only a hinge. Thus, the cost is reduced greatly. In the present invention, each sleeve has a triangular shape and has three tongues so that the flexibility of the sheets achieves a maximum value and the tolerance thereof is increased.

Another object of the present invention is to provide a free-positioning hinge, wherein at each apex of the triangular sheet aside the main axial hole is disposed with a semi-circular sub-hole so as to increase the flexibility of the equilateral triangular sheets. Therefore, oil stored in the sub-holes can be supplemented to the friction surface between the sleeve and the rotary shaft so as to retain in a lubricating condition. Thereby, the dramatic wearing due to insufficient lubricating oil will not occur and the lifetime of the hinge is prolonged.

The various objects and advantages of the present invention will be more readily understood from the following detailed description when read in conjunction with the appended drawing.

### BRIEF DESCRIPTION OF THE DRAWINGS

FIG. 1 is an exploded perspective view of the sleeve and rotary shaft of the present invention.

FIG. 2 is an schematic perspective view of the sleeve and rotary shaft of the present invention.

FIG. 3 is a schematic view showing that the assembled sleeve and rotary shaft are placed in the connecting seat of a machine body of a device.

FIG. 4 is an assembled view of FIG. 3, wherein a connecting end of the rotary shaft is engaged with a connecting seat of an open-able device.

FIG. 5 is an assembled view of FIG. 4.

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

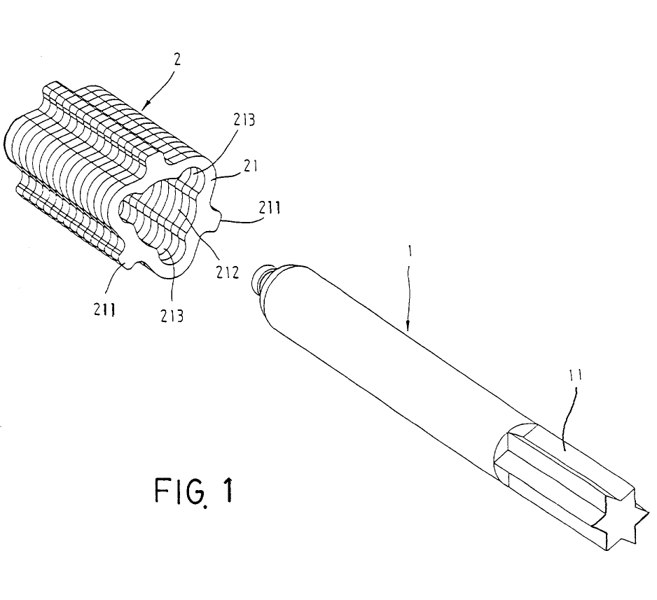

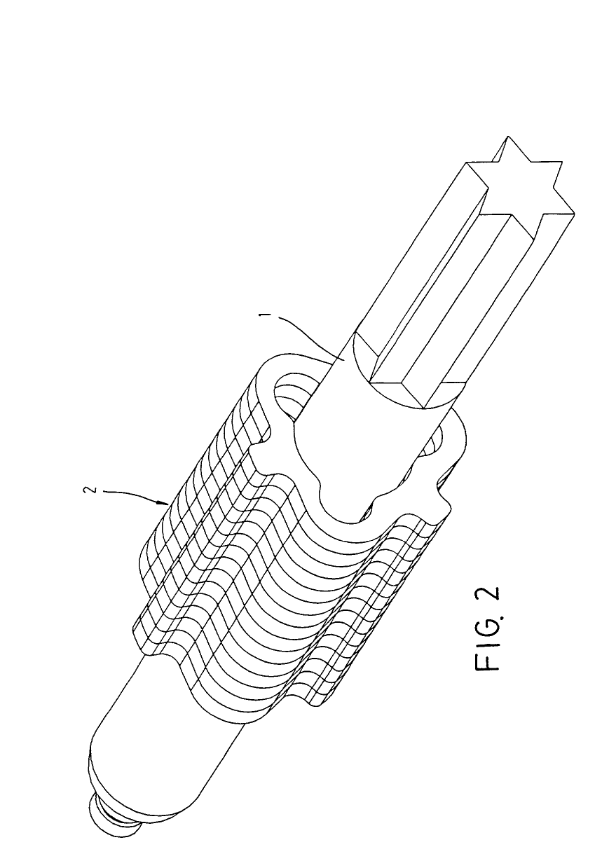

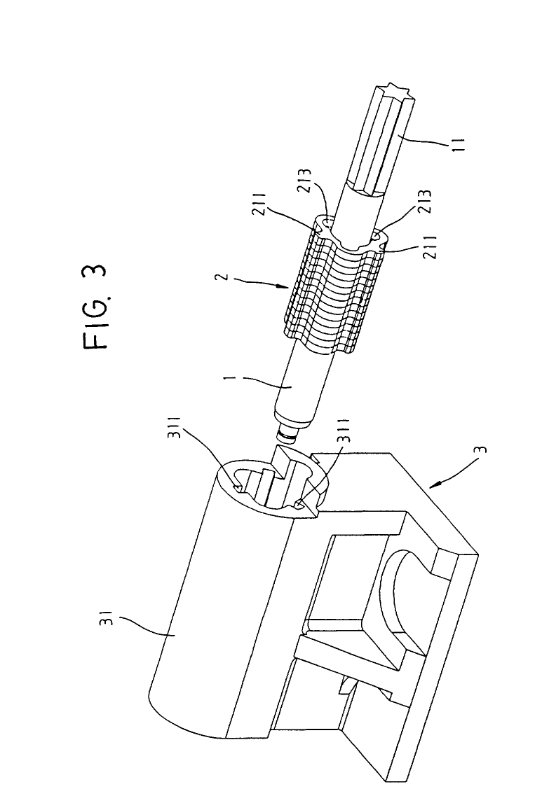

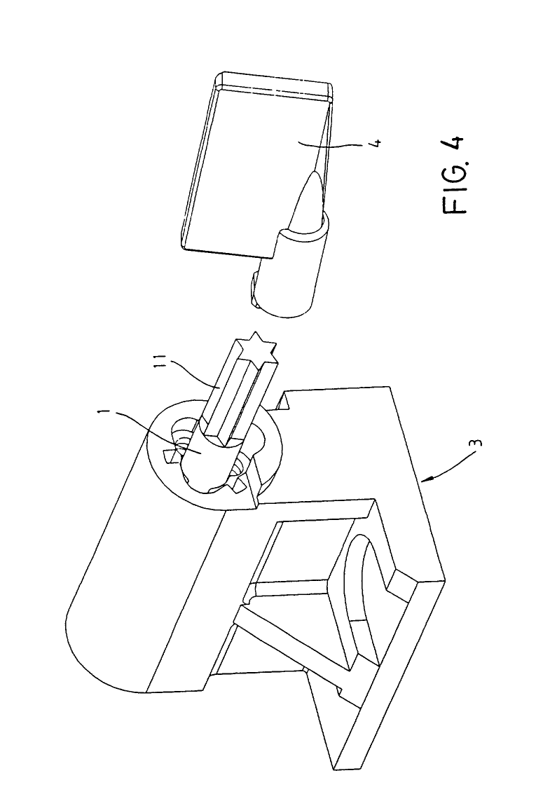

With reference to FIG. 1, an exploded perspective view of the present invention is illustrated. The present invention includes a rotary shaft 1 and a sleeve 2. The sleeve 2 is formed by a plurality of equilateral triangular sheets 21 which are overlapped one by one. At the center portion of each side of each equilateral triangular sheet 21 is extended with a tongue 211 which is utilized as a fixing pin when the sleeve 2 is enclosed by a seat 31 (referring to FIG. 3). The center of the equilateral triangular sheets 21 is formed with a round main axial hole 212 having a diameter approximately equal to that of the rotary shaft 1. Thereby, the rotary shaft 1 can be engaged therein and a friction force is generated therebetween. Furthermore, at each apex of the triangular of each equilateral triangular sheet 21 is disposed with a semi-circular sub-hole 213 communicated with the main axial hole 212 for reducing the friction surface between the main axial hole 212 and the rotary shaft 1. As a result, the flexibility of the equilateral triangular sheets 21 (the rotary shaft 1 is not clamped by the sleeve 2 completely) is increased. After adding lubricating oil, the surplus lubricating oil will flow to the sub-holes 213 to be stored in the holes. Therefore, this stored oil can be supplemented to the friction surface between the sleeve 2 and the rotary shaft 1 so that a lubricating condition is retained between the sleeve 2 and the rotary shaft 1. One end of the rotary shaft 1 is formed as a polygonal connecting end 11 for being connected with a connecting seat 4 (in the following, called as an “active portion”) of open-able element of a device (referring to FIG. 4). The assembled perspective view of the present invention is illustrated in FIG. 2.

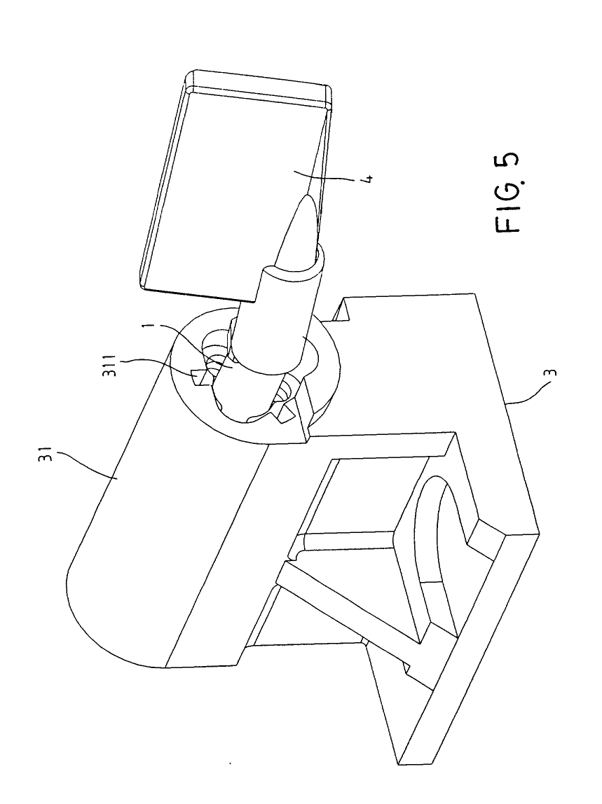

Referring to FIGS. 3 and 5, a schematic view showing an application of a preferred embodiment of the present invention is illustrated. The connecting seat 3 of a machine body of an open-able electronic device (for example, a notebook computer) has a seat 31 which encloses the sleeve 2. Since the sleeve 2 has a triangular shape and has three protruded tongues 211 filled into the respective grooves 311, the sleeve 2 is fixed therein. The movable portion 4 (i.e., the open-able portion) of the device is engaged with the connecting end 11 of the rotary shaft 1. When the movable portion 4 moves, the rotary shaft 1 is driven to rotate. The twisting force due to the weight of the movable portion 4 can be cancelled by the friction force between the rotary shaft 1 and the sleeve 2. Thereby, the object of freely positioning is achieved. In the present invention, the sleeve 2 is designed as a stacked form and the length thereof is determined by the number of the equilateral triangular sheets 21. If a larger friction force (with respect to a larger twisting force) is required, the number of the sheets 21 can be increased. On the contrary, if a smaller friction force is required, the number of the sheets is reduced. Therefore, it is unnecessary to make several molds for making a mold. Thus, the cost is reduced greatly. In the present invention, the sleeve 2 has a triangular shape and then three tongues 211 so that the flexibility of the sheets achieves a maximum value and the tolerance thereof is increased.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A free-positioning hinge comprising a rotary shaft and a sleeve; said rotary shaft being connected to an open-able element, and said sleeve being confined to a seat of a device; characterized in that: said sleeve is formed by stacking a plurality of triangular sheets, each outer side of each of said plurality of triangular sheets is protruded with a tongue; a center of each said triangular sheet has a round main axial hole; a diameter of said main axial hole is approximately equal to an outer diameter of said rotary shaft, thereby, said rotary shaft is capable of being pivotally engaged in said sleeve; thus, a friction force is generated between said rotary shaft and said sleeve; and at least one sub-hole is formed aside said main axial hole and is communicated with said main axial hole.

2. The free-positioning hinge as claimed in claim 1, wherein each said triangular sheet is an equilateral triangular sheet.

3. The free-positioning hinge as claimed in claim 1, wherein said sub-hole is at an apex of said triangular sheet.

4. The free-positioning hinge as claimed in claim 1, wherein said sub-hole has a semicircle shape.

5. The free-positioning hinge as claimed in claim 1, wherein said tongue is confined in a groove of said seat of said device, wherein said groove is configured and positioned with respect to said tongue.
